(19) United States
(12) Patent Application Publication
(10) Pub. No.: US 2015/0340921 A1
(43) Pub. Date: Nov. 26, 2015

(54) ELECTRIC POWER TOOL

(71) Applicant: MAKITA CORPORATION, Anjo-shi (JP)

(72) Inventors: Hidekazu SUDA, Anjo-shi (JP); Masaaki FUKUMOTO, Anjo-shi (JP); Kenta EGUCHI, Anjo-shi (JP); Kazuya ARAKAWA, Anjo-shi (JP); Takuya KUSAKAWA, Anjo-shi (JP)

(73) Assignee: MAKITA CORPORATION, Anjo-shi (JP)

(21) Appl. No.: 14/711,008

(22) Filed: May 13, 2015

(30) Foreign Application Priority Data
May 26, 2014 (JP) 2014-108350

(51) Int. Cl. H02K 5/04; H02K 7/14

(52) U.S. Cl. CPC H02K 5/04; H02K 7/145

(57) ABSTRACT

An electric power tool comprises: a motor configured to drive a tool; a control unit configured to control the motor; a communication board comprising an antenna and a communication circuit, which are configured to establish close-proximity wireless communication with an external communication terminal; and a housing configured to house the motor, the control unit, and the communication board. The housing comprises a grip portion having a hollow space, which is to be gripped by a user. The communication board is arranged inside the grip portion.

### CROSS-REFERENCE TO RELATED APPLICATIONS

This application claims the benefit of Japanese Patent Application No. 2014-108350 filed May 26, 2014 in the Japan Patent Office, the entire disclosure of which is incorporated herein by reference.

### BACKGROUND

The present disclosure relates to an electric power tool having a communication function to establish wireless communication with an external device.

The following system for managing a state of a pneumatic tool has been known: a pneumatic tool comprises RFID tags, and an air compressor comprises an RFID reader/writer; and the air compressor can manage, via the RFID reader/writer, the state of the pneumatic tool (for example, see Japanese patent No. 4797397).

### SUMMARY

The air compressor has a large main body and a large area over which

RFID tags can be held or passed and thus, has greater flexibility in arrangement of a communication circuit board. The pneumatic tool operates with compressed air supplied from the air compressor. The pneumatic tool does not include a motor nor an electric circuit for the motor, which causes interference in the communication. Therefore, in the pneumatic tool, an area for arranging RFID tags can be easily obtained.

However, when a communication board having a communication function such as RFID tags and an RFID reader/writer is intended to be housed in an electric power tool (for example, a small-sized, handheld-operable electric tool), an arrangement area for the communication board cannot be easily obtained.

That is to say, since the electric power tool is configured to include a motor or a control unit for controlling the motor, a communication board needs to be arranged in the electric power tool so that communication can be established without being affected by the motor and control unit. Consequently, an arrangement area for the communication board is restricted.

In view of the above, one aspect of the present disclosure is to arrange a communication board in an electric power tool such that stable communication can be established without being affected by other components, such as a motor, other than the communication board.

An electric power tool in one aspect of the present disclosure comprises: a motor configured to drive a tool; a control unit configured to control the motor; a communication board comprising an antenna and a communication circuit, which are configured to establish close-proximity wireless communication with an external communication terminal; and a housing configured to house these components. The housing comprises a grip portion having a hollow space, which is to be gripped by a user. The communication board is disposed inside the grip portion.

With this configuration, the communication board is disposed at a position at which the user is not obstructed to grip the tool by hands. Therefore, by holding or passing the external communication terminal over the position, the communication board can establish stable communication with the external communication terminal.

In addition, as an area where the communication board can wirelessly communicate with the external communication terminal, an accessible area wider than at least a width of the user's palm can be obtained. For this reason, if the user uses, as the external communication terminal, a hand-held and hand-operable portable communication terminal (for example, cell phones, smartphones, etc.), communication with the communication board can be established in a more stable manner.

Here, regarding the housing of the electric power tool, the housing as a whole including the grip portion is generally divided into two along a central axis, so that components such as a motor, etc. can be easily housed.

In such a case where the grip portion is divided into two along a dividing plane that is along the central axis of the grip portion, the communication board may be disposed so as to be parallel to the dividing plane of the grip portion.

That is to say, in this configuration, the communication board can be easily housed in the grip portion, and therefore, assembling operability during manufacturing can be improved. Also, the grip portion can be easily molded.

Moreover, the grip portion generally has a substantially oval cross section; when being divided into two, the grip portion is divided such that the dividing plane is along a longitudinal axis of the oval. For this reason, when the communication board is arranged so as to be parallel to the dividing plane as described above, a communicable area around an outer periphery of the grip portion, in which the communication board can communicate with the external communication terminal, becomes broader. This can also enhance stability of the communication.

Moreover, when the communication board is disposed to be parallel to the dividing plane of the grip portion, the communication board may be disposed at a position that is closer to one of two members divided along the dividing plane than the dividing plane. In this case, the communication board is made to be closer to one of exterior walls of the grip portion. Accordingly, by holding and passing the external communication terminal over this exterior wall, stability of the communication can be further enhanced.

Moreover, when the communication board is disposed on a same plane as the dividing plane, respective distances from the communication board to the exterior walls located at both sides across the communication board are equal to each other. Consequently, from whichever side the external communication terminal is held or passed over, stable communication can be ensured. In this case, improved convenience can be achieved in communication with the communication board using the external communication terminal.

Furthermore, as described above, when the communication board is disposed so as to be parallel to the dividing plane of the grip portion, the communication board may be provided with a hole configured to secure the communication board inside the grip portion; and in the grip portion, a projection may be provided in one of two members divided along the dividing plane, the projection being configured to be penetrated through the hole of the communication board, thereby to secure the communication board inside the grip portion.

In the aforementioned configuration, it is not necessary to use a screw to secure the communication board inside the grip portion. This reduces operation steps for tightening screws during manufacturing, which significantly improves assembling operability at the time of manufacturing.

In addition, there is no need to consider a size of a boss for a screw and a size of a hole in the board, which are to be formed in the grip portion. As a result, the electric power tool can be downsized. Also, for example, if the projection to be formed in the grip portion has an elongated pin-like shape, a size of the hole to be formed in the board can be made smaller, enabling size reduction of the board.

In a case where in the communication board, the antenna is configured with a conductor pattern formed of a coil, when the hole is provided outside of the conductor pattern constituting the antenna, the communication board is to be supported by the projection of the grip portion, at an outer side of the board. Therefore, the board is less likely to be deformed. In this case, when the communication board is housed inside the grip portion, bending of the communication board can be inhibited.

On the other hand, if the hole is provided inside of the conductor pattern, it is possible to configure that a size of the communication board corresponds to an outer periphery of the conductor pattern; and therefore, the size of the communication board can be further reduced.

Furthermore, wires that connect electric parts including the motor, the control unit, and the communication board, etc. are to be housed inside the housing of the electric power tool. In this case, a wire extending through the grip portion may be disposed between a member provided with the projection and the communication board.

With this configuration, when the communication board is secured to one member forming the grip portion, the wires can be simultaneously positioned inside the grip portion, and therefore, improved assembling operability at the time of manufacturing can be achieved.

Moreover, the communication board may have an asymmetrical shape in a case where a center line of a board surface of the communication board is an axis of symmetry, and may have an asymmetrical shape in a case where a center point of the board surface is a point of symmetry.

That is to say, in this configuration, when the communication board is arranged so as to be parallel to the dividing plane of the grip portion, the board can be arranged without wrongly orienting the board nor wrongly placing a surface side and a reverse side thereof, thereby improving assembling operability at the time of manufacturing.

However, in the case that the grip portion is divided into two as described above, the communication board is not necessarily arranged to be parallel to the dividing plane; rather, the board surface may be arranged orthogonal to the dividing plane.

To enable this configuration, in the grip portion, a supporting part may be provided in at least one of two members divided along the dividing plane; the supporting part is configured to support the communication board when the communication board is inserted in a direction of the board surface.

Furthermore, the control unit may be formed in the communication board. Alternatively, the control unit may be configured to be a separate body from the communication board and connected to the communication board via a lead wire.

In the case that the control unit is configured to be a separate body from the communication board, the control unit (for example, a motor control board on which the control unit is formed) can be disposed without being restricted by a position of the communication board. This allows enhanced flexibility in design of an electric power tool.

The communication circuit provided in the communication board may be configured to establish close-proximity wireless communication using load modulation, via the antenna.

The close-proximity wireless communication using load modulation has been put into practical use as communication/transmission for RFID tags and IC cards, for example, NFC (Near Field Communication); the close-proximity wireless communication using load modulation is to respond by using a transmission signal (carrier wave) from the external communication terminal.

As above, when the communication circuit is configured to use close-proximity wireless communication using load modulation, although communication range is short, electric-power consumption necessary for communication can be greatly reduced, and also, ensured reliability of the communication with the external communication terminal can be obtained.

Furthermore, the grip portion may be provided with a mark indicating a position of the communication board by a concave-convex shape on a surface of an exterior wall of the housing constituting the grip portion.

In this configuration, when the user holds or passes the external communication terminal over the communication board so as to communicate with the communication board, the communication terminal can be easily arranged at an appropriate position for communication, thereby improving operability of the communication terminal.

### BRIEF DESCRIPTION OF THE DRAWINGS

Hereinafter, embodiments of the present disclosure will be described by way of example with reference to the accompanying drawings, in which:

FIG. 1 is a perspective view showing an appearance of a rechargeable screwdriver according to an embodiment of the present disclosure;

FIG. 2 is a block diagram showing a circuit configuration of the rechargeable screwdriver of the embodiment;

FIG. 3 is an illustrative view showing an internal configuration of a grip portion of the rechargeable screwdriver of the embodiment;

FIG. 4 is a cross-sectional view taken along a line IV-IV shown in FIG. 3;

FIG. 5 is a cross-sectional view taken along a line V-V shown in FIG. 3;

FIG. 6 is an enlarged perspective view showing the grip portion of the rechargeable screwdriver of the embodiment;

FIG. 7 is an illustrative view showing a modified embodiment of an arrangement of a communication board;

FIG. 8 is a perspective view showing one example of a rechargeable driver drill to which the present disclosure can be applied;

FIG. 9 is a perspective view showing one example of a rechargeable impact driver to which the present disclosure can be applied;

FIG. 10 is a perspective view showing one example of a rechargeable circular saw to which the present disclosure can be applied;

FIG. 11 is a perspective view showing one example of a rechargeable hammer driver to which the present disclosure can be applied;

FIG. 12 is a perspective view showing one example of a rechargeable grinder to which the present disclosure can be applied;

FIG. 13 is a perspective view showing one example of an alternating-current driven (AC-driven) grinder to which the present disclosure can be applied;

FIG. 14 is a perspective view showing another example of an AC-driven grinder to which the present disclosure can be applied;

FIG. 15 is a perspective view showing one example of an AC-driven hammer drill to which the present disclosure can be applied; and

FIG. 16 is a perspective view showing one example of an AC-driven sliding circular saw to which the present disclosure can be applied.

### DETAILED DESCRIPTION OF THE PREFERRED EMBODIMENTS

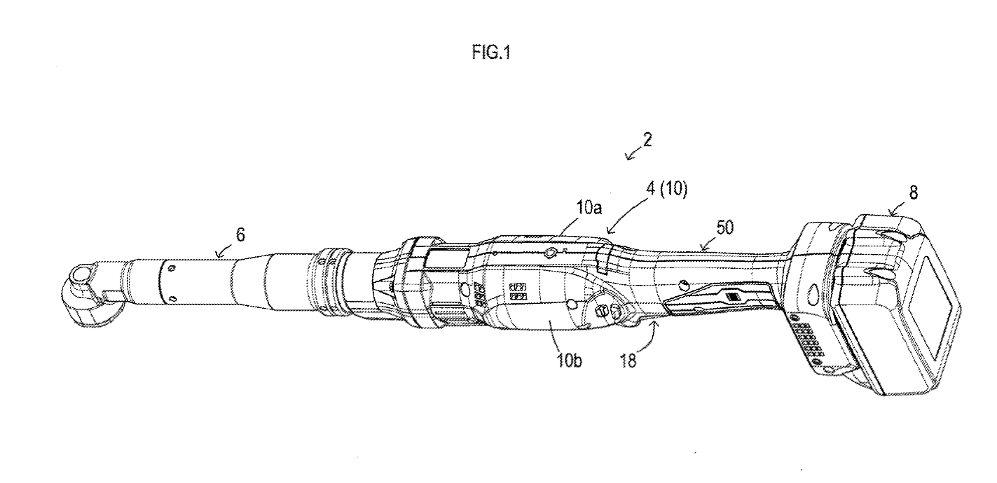

As shown in FIG. 1, a rechargeable screwdriver 2 of the present embodiment comprises a main body 4 having an elongated shape, an angle head 6, and a battery pack 8. The angle head 6 is detachably attached to one longitudinal end of the main body 4. The battery pack 8 is detachably attached to the other longitudinal end of the main body 4.

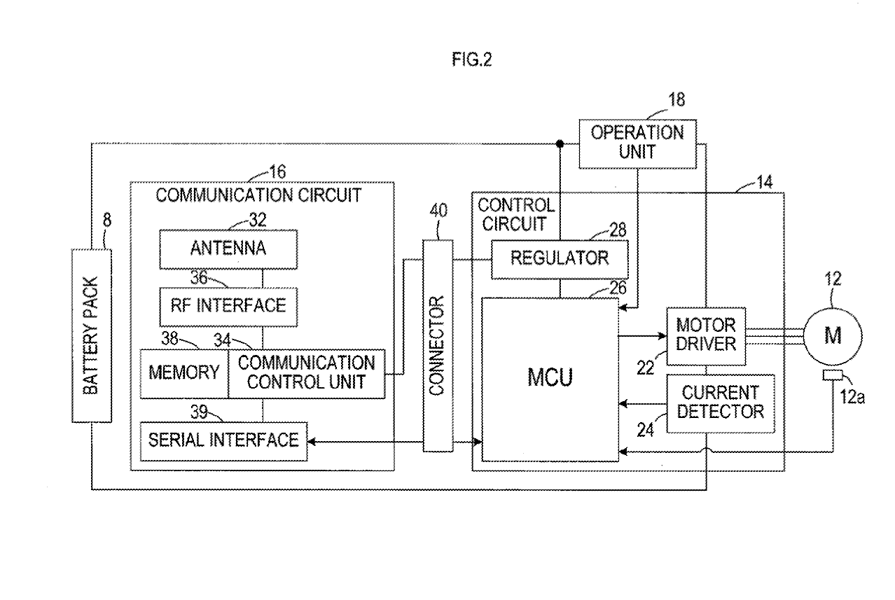

A motor 12 (see FIG. 2) that rotationally drives the angle head 6 is housed in the one end of the main body 4, to which the angle head 6 is to be attached. The angle head 6 is configured to transmit rotation of the motor 12, via an internal gear mechanism, to a tip tool bit by converting the rotation of the motor 12 to rotation about a rotation axis, which is different from the rotation axis of the motor 12.

The main body 4 comprises a housing 10 of radio-wave transmissive synthetic resin, having a hollow cylindrical interior. Inside the housing 10, the motor 12, a control circuit 14, a communication circuit 16, and an operation unit 18 are housed (see FIG. 2).

The operation unit 18 is configured to be externally operated by a user to input a drive command of the motor 12. The control circuit 14 is configured to operate with an electric power supply from the battery pack 8 and controls driving of the motor 12 in accordance with a command from the operation unit 18.

As shown in FIG. 2, the control circuit 14 comprises a motor driver 22, a current detector 24, and an MCU (Micro Control Unit) 26. The motor driver 22 energizes the motor 12 (in the present embodiment, brushless motor) to drive the motor 12. The current detector 24 detects electric current flowing through the motor 12.

The MCU 26 is configured to execute a drive control process for the motor 12 based on detection signals from a rotation sensor 12a provided in the motor 12 and from the current detector 24. In the drive control process, conduction current to the motor 12 is controlled via the motor driver 22, such that the motor 12 is in a rotation state corresponding to the command from the operation unit 18.

The control circuit 14 also comprises a regulator 28 that generates a power supply voltage for driving internal circuits upon receipt of an electric power supply from the battery pack 8. Here, the control circuit 14 corresponds to a control unit of the present disclosure.

The communication circuit 16 is configured to establish short-range wireless communication with an external portable device, such as smartphones. The communication circuit 16 comprises an antenna 32, a communication control unit 34, and an RF interface 36 that connects between the antenna 32 and the communication control unit 34.

The antenna 32 is configured as a conductor pattern in the form of coils formed on a circuit board. The communication control unit 34 is configured to establishes, via the antenna 32, short-range wireless communication using load modulation with an external communication terminal

In addition, the communication circuit 16 comprises a memory 38 and a serial interface 39. The memory 38 stores various information that is necessary to communicate with the external communication terminal. The serial interface 39 is configured to establish data communication with the MCU 26 of the control circuit 14.

The communication control unit 34 establishes short-range wireless communication with the external portable device based on communication information stored in the memory 38. By the short-range wireless communication, data is transmitted to and/or received from the portable device, and the data is further transmitted to and/or received from the MCU 26. Thereby, the communication control unit 34 relays the communication between the MCU 26 and the portable device.

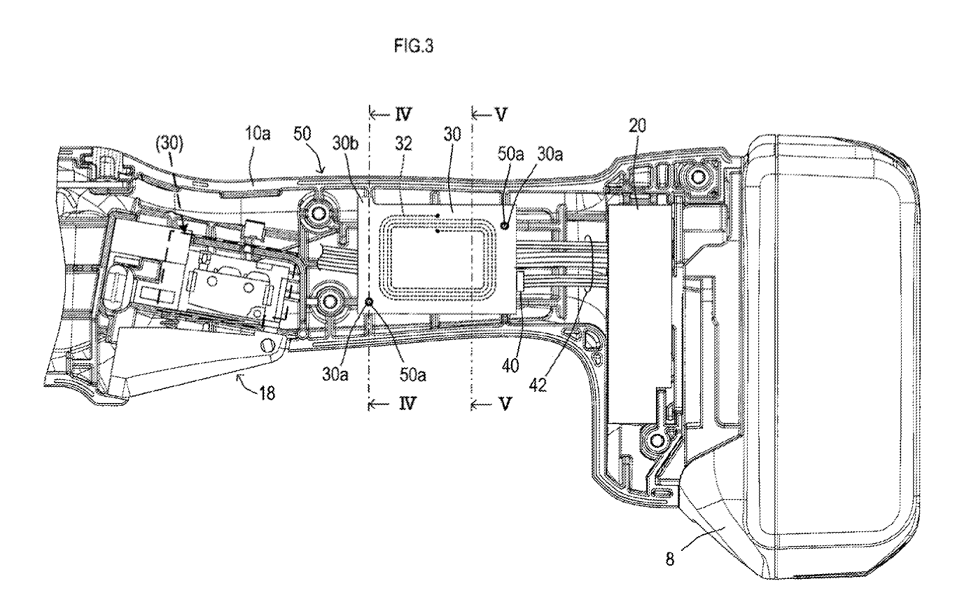

The control circuit 14 and the communication circuit 16 are configured with different circuit boards from each other (which are, respectively, a control board 20 and a communication board 30 shown in FIG. 3) on which electronic components are mounted. The control circuit 14 and the communication circuit 16 are connected via a connector 40.

Among multiple wires 42 drawn from the control board 20, the connector 40 is secured to end portions of lead wires to be connected to the communication board 30.

Specifically, the connector 40 is connected to a lead wire for communication, which connects between a communication port of the MCU 26 and the serial interface 39 of the communication circuit 16; and also, the connector 40 is connected to a lead wire for supplying power source to the communication control unit 34 from the regulator 28.

The housing 10 of the main body 4 is divided into two parts along a longitudinal central axis of the housing 10. The main body 4 is assembled such that components are mounted to a housing member 10a (see FIGS. 1 and 3), which is one of the two divided parts, and that a housing member 10b (see FIG. 1), which is the other of the two divided parts, is overlaid and screwed onto the housing member 10a. Here, the aforementioned components in the main body 4 are the motor 12, the control board 20, the communication board 30, the operation unit 18, etc., which have been described above.

In the housing 10, a grip portion 50 for allowing a user to grip is provided in a portion between a front end section of the housing 10, to which the motor 12 is housed and the angle head 6 is to be attached, and a rear end section of the housing 10, to which the battery pack 8 is to be attached.

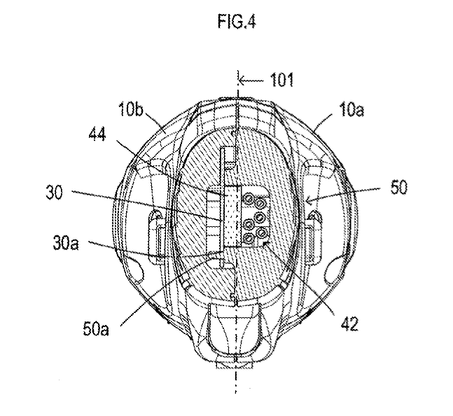

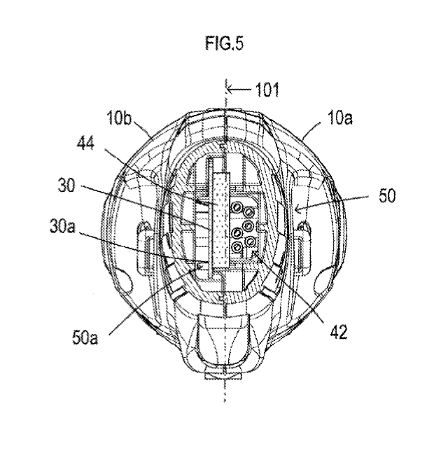

The grip portion 50 is provided to allow the user to use the rechargeable screwdriver 2 by gripping with one hand of the user. In order to allow the user to easily grip the grip portion 50 and operate the operation unit 18 while gripping the grip portion 50, an outer circumference of the grip portion 50 around a central axis of the main body 4 has an oval cross section narrower than a cross section of an outer circumference of portions other than the grip portion 50 (see FIGS. 4 and 5).

As shown in FIGS. 4 and 5, the housing 10 is divided along a dividing plane 101 that is in a direction of a longitudinal axis of the oval shape as the cross-sectional shape of the grip portion 50; in the grip portion 50, the communication board 30 is disposed such that a board surface thereof is parallel to the dividing plane 101 of the housing 10.

Specifically, the board surface of the communication board 30 is formed to be substantially rectangular. A pair of holes 30a is formed in corner portions of the communication board 30; the corner portions are located diagonally across a central axis of the communication board 30 from each other. A pair of pins 50a is provided in a protruding manner in the housing member 10a that forms the grip portion 50. The communication board 30 is secured to the housing member 10a by penetrating the pair of pins 50a through the pair of holes 30a.

The hole 30a has an inner diameter that is substantially equal to an outer diameter of the pin 50a. For this reason, when the pins 50a are penetrated into the holes 30a, the pins 50a and the holes 30a are fit into each other, which enables the communication board 30 to be firmly secured inside the grip portion 50,

Moreover, the pin 50a has a height that is higher than the dividing plane 101 in the housing member 10a, Accordingly, when the communication board 30 is secured to the pins 50a, the communication board 30 is to be located closer to a housing member 10b side than the dividing plane 101.

On the board surface of the communication board 30 in the housing member 10b side, the antenna 32 is formed by the above-described conductor pattern in the form of coils.

Thus, in the grip portion 50, the antenna 32 is located closer to the housing member 10b than the housing member 10a. For this reason, if a portable device is held or passed over the grip portion 50 to communicate with the communication circuit 16, it is desirable to hold or pass the portable device over the housing member 10b side.

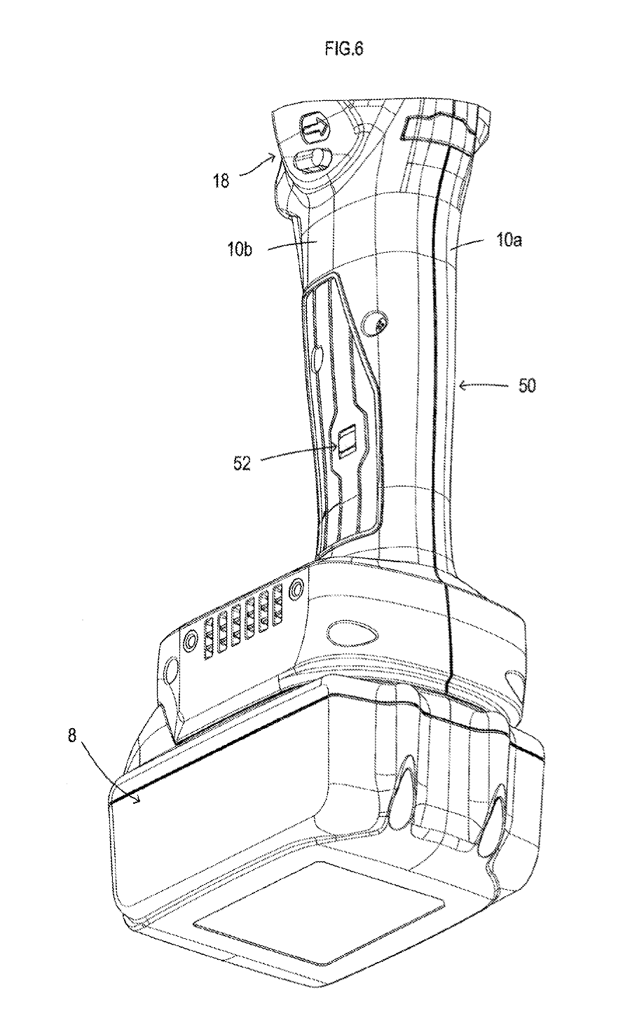

In view of the above, in the present embodiment, among the housing members 10a and 10b forming the grip portion 50, formed on an exterior wall of the housing member 10b is a mark 52 for indicating that the communication circuit 16 is arranged inside the housing member 10b, as shown in FIG. 6.

In order to ensure that the mark 52 does not disappear during use, the mark 52 is provided by forming a concave-convex shape, on the exterior wall of the housing member 10b. Moreover, in the communication board 30, a projecting piece 30b is formed in one of four corner portions thereof such that the communication board 30 is not symmetrical about a center point of the board surface (in other words, asymmetry).

Furthermore, in the housing member 10a, in a case where two of the pins 50a in the grip portion 50 are penetrated through the holes 30a of the communication board 30, if the board is placed in an opposite direction, the projecting piece 30b extends outwardly from an engaging portion of the housing members 10a and 10b; consequently, the communication board 30 cannot be housed within the grip portion 50.

On the other hand, the control board 20 is housed inside the housing 10 in a rear end side of the main body 4 (i.e., the side to which the battery pack 8 is to be attached).

Among the multiple wires 42 drawn from the control board 20, wires for connecting the control board 20 to the motor 12 and the operation unit 18 are disposed between the communication board 30 and the housing member 10a.

Electronic components other than the antenna 32 constituting the communication circuit 16 are mounted on the board surface of the communication board 30 in the housing member 10a side. Specifically, the aforementioned electronic components are the communication control unit 34, the RF interface 36, the memory 38, the serial interface 39, connection terminals to the connector 40, and so on.

In this board surface, a buffer member 44 made of sponge, etc. is provided (see FIGS. 4 and 5) so as to eliminate the following problem: the wires 42 come in contact with the electronic components mounted on the communication board 30, causing deterioration of coating of the wires 42 with long-term use of the rechargeable screwdriver 2.

As described above, according to the rechargeable screwdriver 2 in the present embodiment, the communication board 30 is arranged inside the grip portion 50 provided in the housing 10 of the main body 4, and the mark 52 that indicates a position of the communication board 30 is provided in the exterior wall of the grip portion 50.

This allows the user to see the mark 52 and easily identify a position over which the portable device is to be held or passed. In addition, the user holds or passes over the portable device in this position, which can establish stable communication between the portable device and the communication board 30.

Moreover, an accessible area that is greater than a width of the user's palm can be obtained as an area where the communication board 30 can wirelessly communicate with the portable device. Consequently, the portable device can be easily made close to the communication board 30 (specifically, the antenna 32), and the portable device can stably communicate with the communication board 30.

Furthermore, the communication board 30 can be easily secured inside the grip portion 50, by penetrating the pins 50a, which are provided in a protruding manner in the housing member 10a constituting the grip portion 50, through the holes 30a, which are formed in the communication board 30; this enables improved assembling operability of the housing during manufacturing.

The holes 30a of the communication board 30 are formed in the corner portions of the communication board 30 (i.e., outside of the conductor pattern in the form of coils that forms the antenna 32). Accordingly, the communication board 30 is configured to be supported at around an outer circumference thereof, via the pins 50a.

For this reason, when the communication board 30 is housed inside the grip portion 50, the communication board 30 is less likely to be deformed. It is possible to suppress bending of the communication board 30 and change of directional characteristics of the antenna 32, due to long-term use of the rechargeable screwdriver 2.

Moreover, in the communication board 30, the projecting piece 30b is formed in one of four corner portions thereof such that the communication board 30 is not symmetrical about the center point of the board surface (in other words, asymmetry). Therefore, in a case of housing the communication board 30 in the grip portion 50, it is possible to inhibit an incorrect arrangement of the communication board 30 in a wrong direction, thereby improving the assembling operability during manufacturing.

The communication circuit 16 is configured to establish close-proximity wireless communication using load modulation, via the antenna 32; thus, the communication circuit 16 can easily communicate wirelessly with the portable device (smartphones, etc.) having a function as a reader/writer for RFID tags and IC cards.

In the close-proximity wireless communication using load modulation, although communication range is short, highly reliable communication can be established with extremely low electric-power consumption. For this reason, when the close-proximity wireless communication using load modulation is applied to a rechargeable electric power tool that receives electric power supply from the battery pack 8, effects of this close-proximity wireless communication can be exhibited.

The wires 42, which connect between the control board 20, and the motor 12 and the operation unit 18, are disposed between the communication board 30, and the housing member 10a to which the communication board 30 is to be mounted. This inhibits the wires 42 from obstructing assembling of the main body 4 in which the housing member 10a and the housing member 10b are fitted to each other.

Although one embodiment of the present disclosure has been described as above, the present disclosure should not be limited to the above-described embodiment and can be carried out in various modes within a scope of the present disclosure.

For example, in the above-described embodiment, it has been described that the communication board 30 is disposed at a position closer to the housing member 10b side from the dividing plane 101 of the housing members 10a and 10b that constitute the grip portion 50. However, the communication board 30 may be disposed on the dividing plane 101 shown in FIGS. 4 and 5.

Also, as shown by the dashed line in FIG. 3, the communication board 30 may be disposed in an end part of the grip portion 50, to which the operation unit 18 is to be housed, in an overlapping manner with a switch of the operation unit 18.

In the above-described embodiment, it has been described that the holes 30a for securing the communication board 30 within the grip portion 50 are formed outside of the conductor pattern constituting the antenna 32. However, the holes 30a may be provided inside of the conductor pattern. With this configuration, the communication board 30 can be further downsized.

Moreover, in the above-described embodiment, the projecting piece 30b is formed in one of four corner portions of the communication board 30 so as to have a shape asymmetrical about the center point of the board surface. However, the holes 30a may be, for example, provided in a protruding manner in three of four corner portions of the communication board 30. That is, this configuration allows the communication board 30 to have a shape asymmetrical about the center point of the board surface, without providing the projecting piece 30b as in the above-described embodiment; and when this communication board 30 is housed in the grip portion 50, an incorrect arrangement of the communication board 30 in a wrong direction can be inhibited.

Furthermore, it is not necessary to arrange the communication board 30 in parallel to the dividing plane 101 of the housing members 10a and 10b that constitute the grip portion 50; the communication board 30 may be, arranged such that the board surface is orthogonal to (or intersects with) the dividing plane 101.

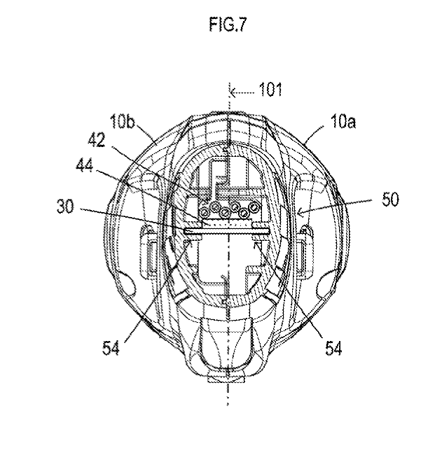

In order to enable this arrangement, as illustrated in FIG. 7, a pair of guide portions 54 may be provided in the housing member 10b or in the housing members 10a and 10b; the pair of guide portions 54 allows the communication board 30 to be inserted in a direction of the board surface, and holds the inserted communication board 30 therebetween.

The above-described embodiment has been explained with respect to a case in which the present disclosure is applied to the rechargeable screwdriver. However, the present disclosure can be applied to a rechargeable electric power tool comprising the battery pack 8, or an AC-driven electric power tool that operates by receiving electric power supply from an external alternating-current power source (generally, commercial power supply).

That is to say, in the same manner as in the above-described embodiment, the present disclosure can be applied to any electric power tool comprising the grip portion 50 to be gripped by a user, thereby obtaining substantially the same effects as effects obtained by the above-described embodiment.

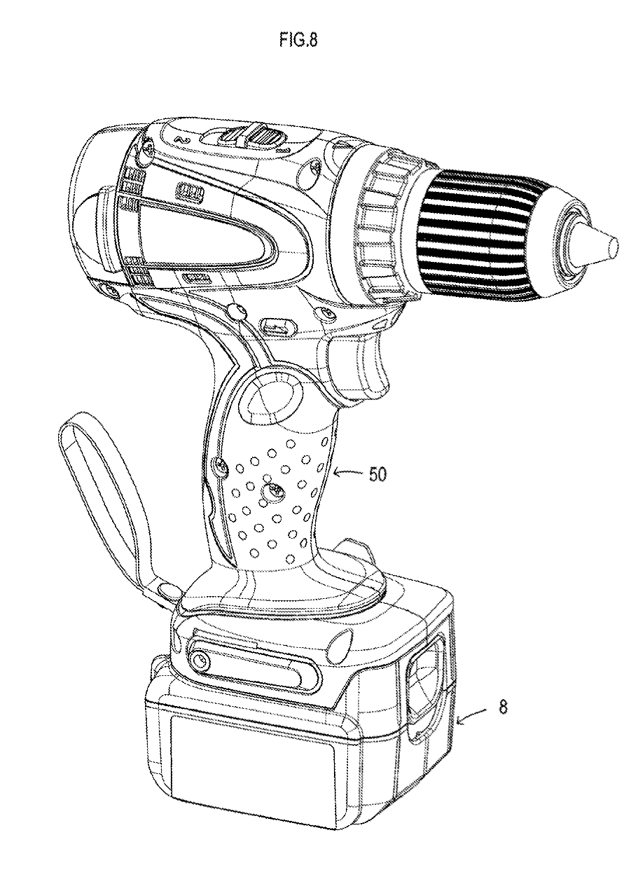

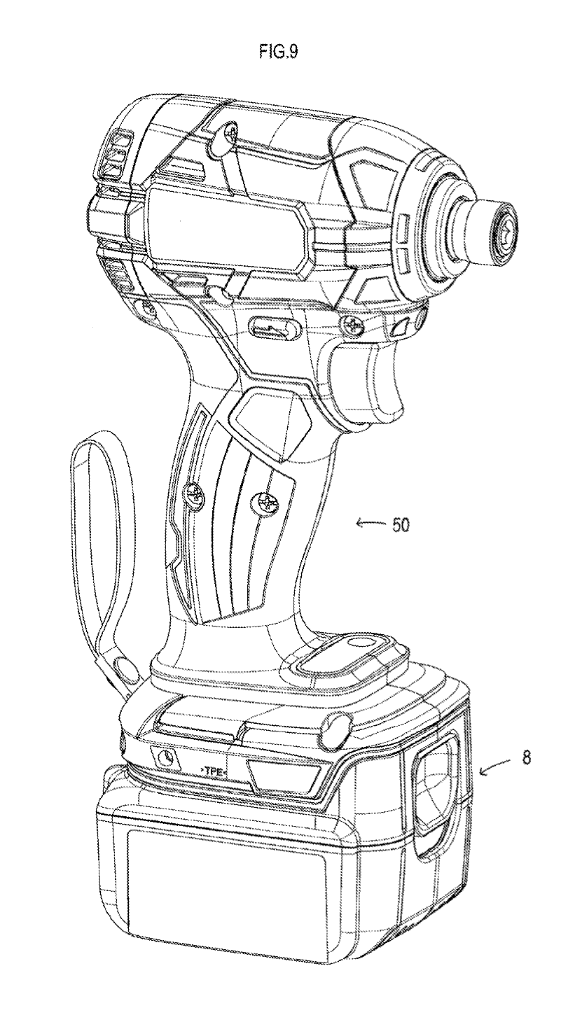

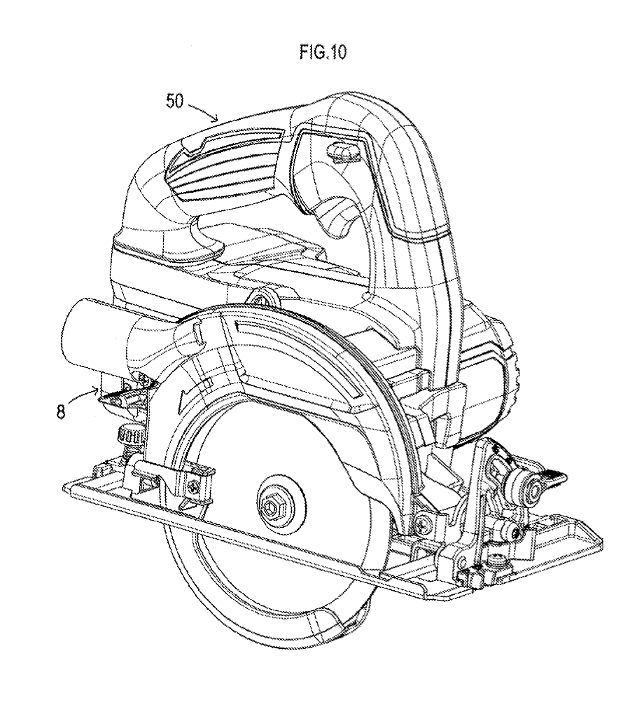

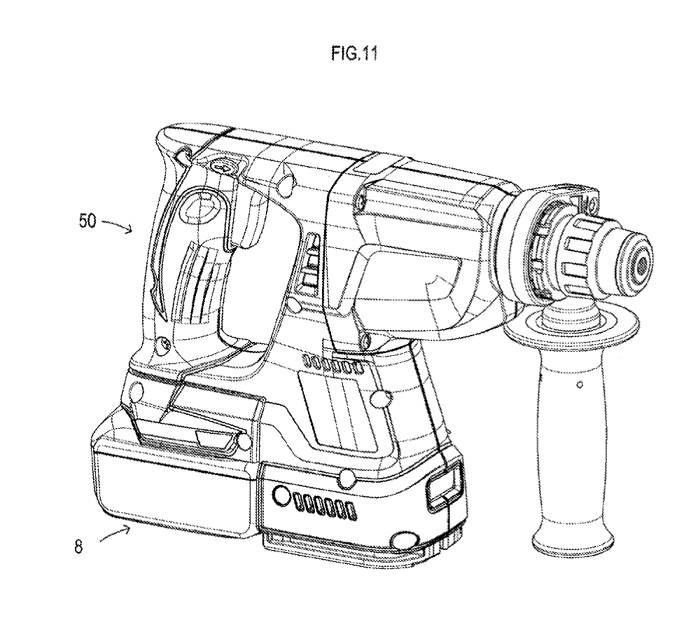

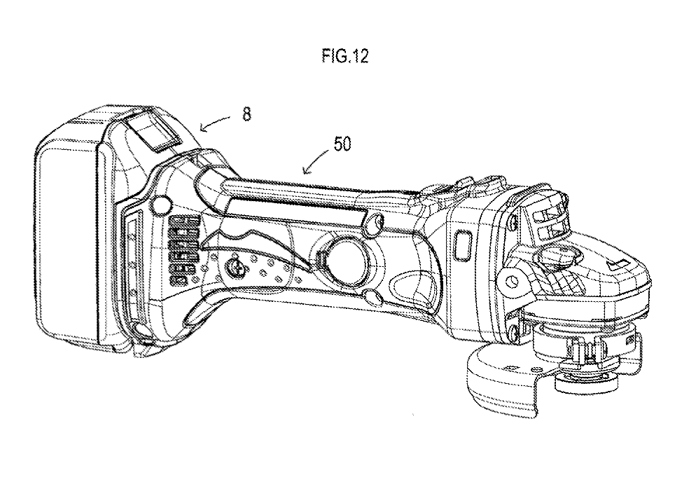

Examples of a rechargeable electric power tool comprising the battery pack 8 and the grip portion 50 include a rechargeable driver drill shown in FIG. 8, a rechargeable impact driver shown in FIG. 9, a rechargeable circular saw shown in FIG. 10, a rechargeable hammer driver shown in FIG. 11, a rechargeable grinder shown in FIG. 12, etc.

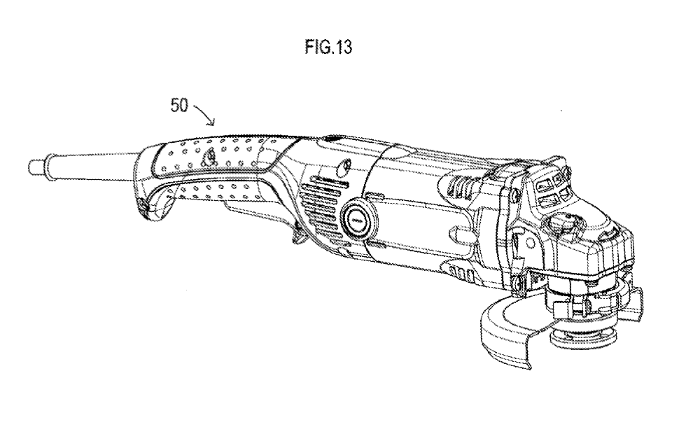

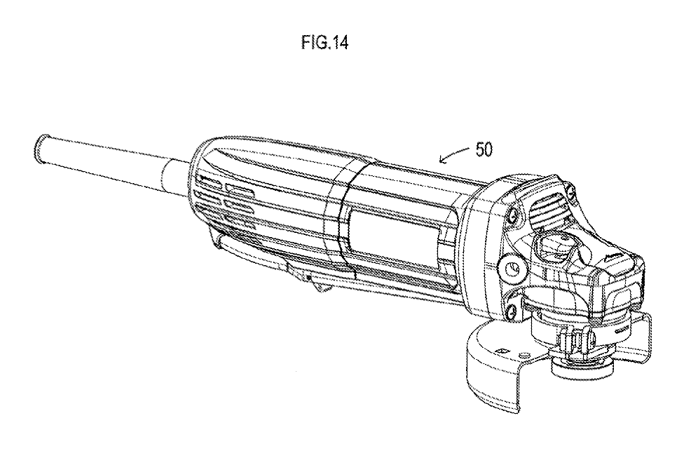

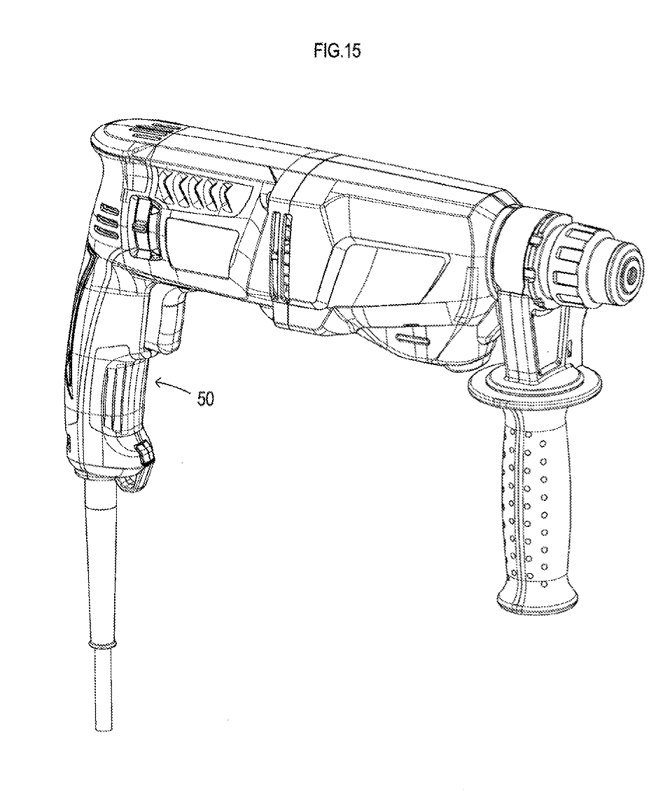

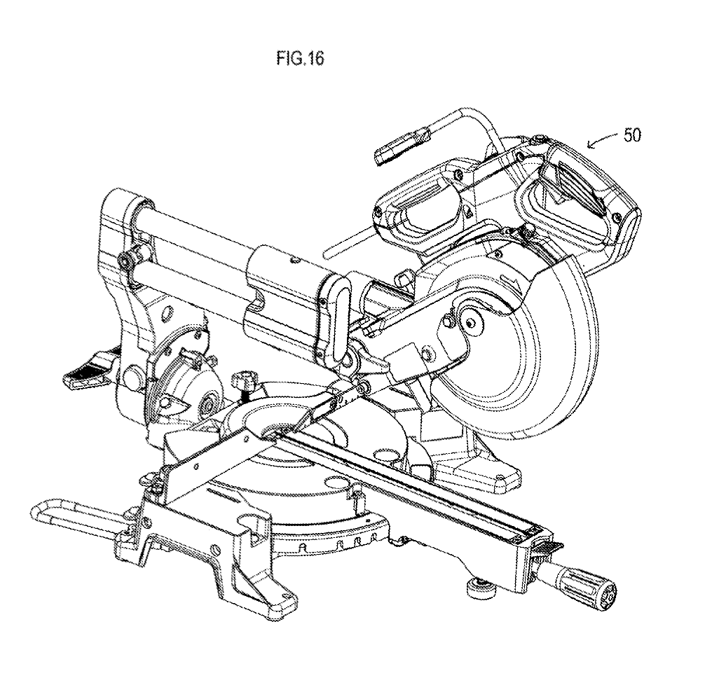

Also, examples of an AC-driven electric power tool comprising the grip portion 50 include an AC-driven grinder shown in FIG. 13, an AC-driven grinder shown in FIG. 14, an AC-driven hammer drill shown in FIG. 15, an AC-driven sliding circular saw shown in FIG. 16, etc.

Any of the electric power tools illustrated in FIGS. 8 to 16 is a known power tool and therefore, detailed configurations thereof will not be explained here.

As described above, according to the present disclosure, the communication board 30 can be disposed commonly in a grip portion in numerous types of tools, which enables stable close-proximity wireless communication.

For a user who uses various tools, any tool can establish communication by holding or passing an external communication terminal over a grip portion in the tool. Thus, the user does not need to each time look for a mark indicating a position of a communication board, on the exterior wall surface; this provides greater convenience to the user.

What is claimed is:

1. An electric power tool comprising:
a motor configured to drive a tool;
a control unit configured to control the motor;
a communication board comprising an antenna and a communication circuit, which are configured to establish close-proximity wireless communication with an external communication terminal; and
a housing configured to house the motor, the control unit, and the communication board;
wherein the housing comprises a grip portion having a hollow space, which is to be gripped by a user, and
wherein the communication board is disposed inside the grip portion.

2. The electric power tool according to claim 1,
wherein in the housing, at least the grip portion is divided into two along a dividing plane that is along a central axis of the grip portion, and
wherein the communication board is disposed so as to be parallel to the dividing plane of the grip portion.

3. The electric power tool according to claim 2,
wherein in the grip portion, the communication board is disposed at a position that is closer to one of two members divided along the dividing plane than the dividing plane.

4. The electric power tool according to claim 2,
wherein the communication board is disposed on a same plane as the dividing plane.

5. The electric power tool according to claim 2,
wherein the communication board is provided with a hole configured to secure the communication board inside the grip portion, and
wherein in the grip portion, a projection is provided in one of two members divided along the dividing plane, the projection being configured to be penetrated through the hole of the communication board, thereby to secure the communication board inside the grip portion.

6. The electric power tool according to claim 5,
wherein in the communication board, the antenna is configured with a conductor pattern formed of a coil, and the hole is provided outside of the conductor pattern.

7. The electric power tool according to claim 5,
wherein in the communication board, the antenna is configured with a conductor pattern formed of a coil, and the hole is provided inside of the conductor pattern.

8. The electric power tool according to claim 5,
wherein among wires that connect, inside the housing, electric parts including the motor, the control unit, and the communication board, a wire extending through the grip portion is disposed between a member provided with the projection and the communication board.

9. The electric power tool according to claim 2,
wherein the communication board has an asymmetrical shape in a case where a center line of a board surface of the communication board is an axis of symmetry, and has an asymmetrical shape in a case where a center point of the board surface is a point of symmetry.

10. The electric power tool according to claim 1,
wherein in the housing, at least the grip portion is divided into two along a dividing plane that is along a central axis of the grip portion, and at least one of two members divided along the dividing plane is provided with a supporting part configured to support the communication board.

11. The electric power tool according to claim 1,
wherein the control unit is configured to be a separate body from the communication board and is connected to the communication board via a lead wire.

12. The electric power tool according to claim 1,
wherein the communication circuit provided in the communication board is configured to establish close-proximity wireless communication using load modulation, via the antenna.

13. The electric power tool according to claim 1,
wherein the grip portion is provided with a mark that indicates a position of the communication board and that is formed by a concave-convex shape on a surface of an exterior wall of the grip portion.
